(19) United States
(12) Patent Application Publication
(10) Pub. No.: US 2026/0035003 A1
(43) Pub. Date: Feb. 5, 2026

(54) VEHICLE CONTROL SYSTEM AND VEHICLE CONTROL METHOD

(71) Applicant: TOYOTA JIDOSHA KABUSHIKI KAISHA, Toyota-shi (JP)

(72) Inventor: Hideo ASAI, Toyota-shi (JP)

(73) Assignee: TOYOTA JIDOSHA KABUSHIKI KAISHA, Toyota-shi (JP)

(21) Appl. No.: 19/182,825

(22) Filed: Apr. 18, 2025

(30) Foreign Application Priority Data
Jul. 30, 2024 (JP) 2024-123194

(51) Int. Cl. B60W 50/14; B60W 30/182; B60W 50/00; H04R 3/12

(52) U.S. Cl. CPC B60W 50/14; B60W 30/182; H04R 3/12; B60W 2050/0083; H04R 2499/13

(57) ABSTRACT

When the startup operation signal from the startup input device is input, a startup sound output processing for outputting the startup sound of the virtual engine generated based on the startup sound source data to the speaker is performed. The startup sound source data includes cranking sound data generated with cranking of the virtual engine and explosion sound data after the first explosion of the virtual engine. The startup sound output processing includes counting an input duration time of the startup operation signal, and switching from the reproduction of the startup sound based on the cranking sound data to the reproduction of the startup sound based on the explosion sound data when the input duration time exceeds a regulation time.

### CROSS-REFERENCE TO RELATED APPLICATION

This application claims priority to Japanese Patent Application No. 2024-123194 filed on Jul. 30, 2024. The disclosure of the above-identified application, including the specification, drawings, and claims, is incorporated by reference herein in its entirety.

### BACKGROUND

### 1. Technical Field

The present disclosure relates to technology that is applied to a vehicle including an electric motor as a drive force source.

### 2. Description of Related Art

Japanese Unexamined Patent Application Publication No. 2022-036005 (JP 2022-036005 A) discloses a control device for a battery electric vehicle that includes an electric motor as a drive force source. This conventional control device estimates an engine load when controlling a virtual engine as the drive force source of a virtual vehicle, based on driving operations of the battery electric vehicle. The conventional control device also estimates a virtual engine sound that is generated in a vehicle cabin of the virtual vehicle when the virtual engine is controlled by the engine load that is estimated. The conventional control device controls audio equipment of the battery electric vehicle such that the virtual engine sound that is estimated is generated in the vehicle cabin of the battery electric vehicle.

### SUMMARY

Now, an engine serving as a drive force source is started up by operating a dedicated input device such as a start switch or the like. The conventional control device is not configured to generate a virtual engine sound based on operation of the input device for starting, and accordingly cannot generate a sound that is generated at the time of startup of the virtual engine.

Note that sound that is generated at the time of startup a typical engine includes a sound that is generated in conjunction with cranking of the engine (cranking sound), and a sound that is generated following a first explosion of the engine (explosion sound). Also, in a typical engine, transition from cranking to the first explosion of the engine may fail when the operation of the input device for startup is insufficient. Accordingly, improvement is desired from the viewpoint of improving reproducibility of the startup sound of the engine serving as the drive force source.

An aspect of the present disclosure is to provide technology that is capable of improving reproducibility of a startup sound of a virtual engine when a virtual engine sound is generated in a vehicle cabin of a battery electric vehicle.

A first aspect of the present disclosure is a vehicle control system that generates, in a vehicle cabin of a real vehicle that includes an electric motor as a drive force source, a virtual engine sound generated in a virtual vehicle that includes a virtual engine as a drive force source, and has the following features.

The vehicle control system includes one or multiple storage devices that store startup sound source data of the virtual engine,
one or multiple processors that generate sound to be output from a speaker of the real vehicle, and
a startup input device of the real vehicle.
   When a startup operation signal is input from the startup input device, the one or multiple processors perform startup sound output processing for outputting, to the speaker, startup sound of the virtual engine that is generated based on the startup sound source data.
   The startup sound source data includes cranking sound data that is generated in conjunction with cranking of the virtual engine, and explosion sound data following a first explosion of the virtual engine.
   The startup sound output processing includes
counting input duration time of the startup operation signal, and
switching from reproduction of the startup sound based on the cranking sound data to reproduction of startup sound based on the explosion sound data when the input duration time exceeds a regulation time.

A second aspect of the present disclosure is a vehicle control method for generating, in a vehicle cabin of a real vehicle that includes an electric motor as a drive force source, a virtual engine sound generated in a virtual vehicle that includes a virtual engine as a drive force source, and has the following features.

The vehicle control method includes performing startup sound output processing by one or multiple processors that generate sound to be output from a speaker of the real vehicle, for outputting, from the speaker of the real vehicle, startup sound of the virtual engine that is generated based on startup sound source data of the virtual engine stored in one or multiple storage devices, when a startup operation signal is input from a startup input device of the real vehicle.
The startup sound source data includes cranking sound data that is generated in conjunction with cranking of the virtual engine, and explosion sound data following a first explosion of the virtual engine.
The startup sound output processing includes
counting input duration time of the startup operation signal, and
switching from reproduction of the startup sound based on the cranking sound data to reproduction of startup sound based on the explosion sound data when the input duration time exceeds a regulation time.

According to the present disclosure, when the startup operation signal is input from the startup input device, the startup sound output processing is performed. In the startup sound output processing, when the input duration time of the operation signal exceeds the regulation time, the startup sound is switched from reproduction of the startup sound based on the cranking sound data to reproduction of the startup sound based on the explosion sound data. Thus, the startup sound of an engine, in which transition from the cranking to the first explosion of the engine occurs in accordance with operation time of the startup input device, can be reproduced in the real vehicle including the electric motor as the drive force source.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram illustrating a vehicle control system according to an embodiment;

FIG. 2 is a block diagram illustrating an example of a functional configuration of the vehicle control device 100 related to output control of a virtual engine sound;

FIG. 3 is a diagram illustrating a driving mode assumed in the embodiment;

FIG. 4 is a block diagram illustrating an example of a functional configuration of a vehicle control device related to output control of a startup sound of a virtual engine;

FIG. 5 is a diagram illustrating an example of generation of engine sound data by a startup sound generating unit;

FIG. 6 is a diagram illustrating an example of generation of engine sound data by a startup sound generating unit;

FIG. 7 is a flow chart showing a flow of a computer process (startup sound output processing) particularly related to the embodiment; and

FIG. 8 is a flowchart illustrating a flow of computer processing (mode setting processing) related to the embodiment.

### DETAILED DESCRIPTION OF EMBODIMENTS

Embodiments of the present disclosure will be described with reference to the accompanying drawings. In the drawings, the same or corresponding components are denoted by the same reference numerals, and the description thereof is simplified or omitted.

### 1. Overall Configuration

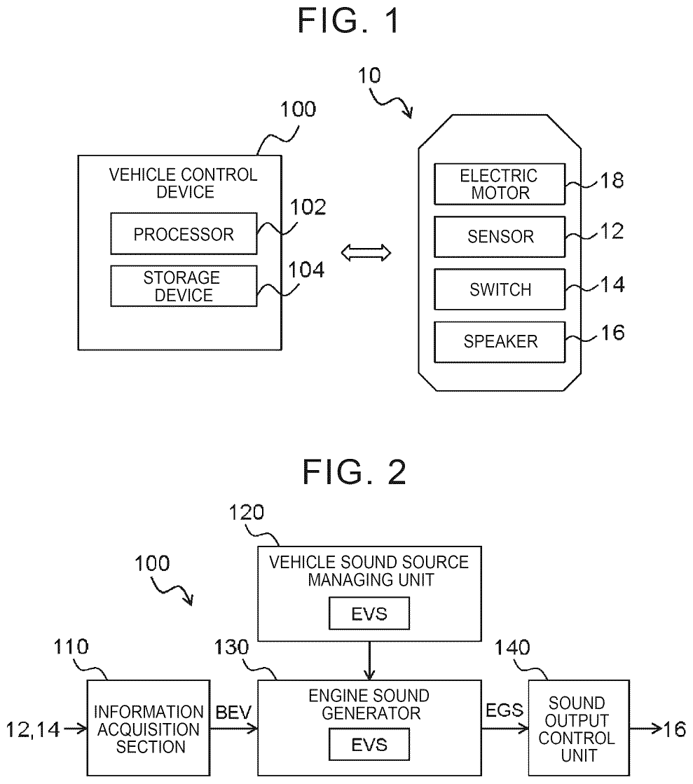

FIG. 1 is a conceptual diagram illustrating a vehicle control system according to an embodiment of the present disclosure. FIG. 1 illustrates a battery electric vehicle 10 as a real vehicle and a vehicle control device 100 applied to this battery electric vehicle 10. Battery electric vehicle 10 comprises an electric motor 18. Examples of the electric motor 18 include a brushless DC motor and a three-phase AC synchronous motor. Battery electric vehicle 10 uses the electric motor 18 as a drive force source for traveling.

Battery electric vehicle 10 also includes various sensors 12. The various sensors 12 include an operation state sensor such as an accelerator position sensor, a brake position sensor, and a shift position sensor, and a travel state sensor such as a wheel speed sensor, an acceleration sensor, and a rotation speed sensor. The accelerator position sensor detects an operation amount (accelerator operation amount) of the accelerator pedal. The brake position sensor detects an operation amount of the brake pedal. The shift position sensor detects the shift position. The wheel speed sensor detects a rotational speed of a wheel of battery electric vehicle 10. The acceleration sensor detects lateral acceleration and longitudinal acceleration of battery electric vehicle 10. The rotational speed sensor detects the rotational speed of the electric motor 18.

The various sensors 12 also include position sensors such as GNSS (Global Navigation Satellite System) sensors. The various sensors 12 also include recognition sensors such as cameras, radars, and LIDAR (Laser Imaging Detection and Ranging). GNSS detects the position and orientation of battery electric vehicle 10. It images at least the front of battery electric vehicle 10. The radar and LIDAR recognize conditions around battery electric vehicle 10.

Battery electric vehicle 10 also includes various switches 14. The various switches 14 include operation switches such as a winker switch, a light switch, and a start switch. The winker switch switches ON/OFF of the turn signal light. The light switch switches ON/OFF of the light (e.g., a headlight). The start switch switches ON/OFF of battery electric vehicle 10 power supply. The start switch is an example of a “startup input device” of the present disclosure. The various switches 14 also include a mode changeover switch for switching the driving mode of battery electric vehicle 10.

Battery electric vehicle 10 further comprises a speaker 16. The speaker 16 outputs sound into the vehicle cabin of battery electric vehicle 10. The speaker 16 includes, for example, a front speaker provided in front of the vehicle cabin and a rear speaker provided in rear of the vehicle cabin. The total number of speakers constituting the speaker 16 and the layout of the speaker 16 can be arbitrarily changed.

Vehicle-control device 100 controls the power of electric motor 18 to drive battery electric vehicle 10. The output control of the electric motor 18 by the vehicle control device 100 includes a normal control for operating battery electric vehicle 10 as a common battery electric vehicle, and a control for operating battery electric vehicle 10 so as to simulate the torque-characteristics of a virtual engine as a drive force source for traveling and a virtual vehicle including a manual transmission (hereinafter, also referred to as “MT engine vehicle”). The power control of the electric motor 18, which simulates the torque-characteristics of MT engine vehicles, is also described in Section 2.

The vehicle control device 100 also generates a sound (hereinafter, also referred to as “indoor sound”) to be output from the speaker 16. The vehicle control device 100 also outputs the generated indoor sound from the speaker 16. For example, the vehicle control device 100 generates a sound (hereinafter, also referred to as “virtual engine sound”) generated by the virtual engine, and outputs the generated virtual engine sound as an indoor sound from the speaker 16. In another example, the vehicle control device 100 generates an indoor sound including a virtual engine sound, and outputs the generated indoor sound from the speaker 16. Output control of virtual engine sounds is also described in Section 3.

The entire vehicle control device 100 may be mounted on a battery electric vehicle 10. As another example, at least a portion of the vehicle-control device 100 may be included in an administration server external to battery electric vehicle 10. In this case, the vehicle control device 100 may remotely generate the indoor sound, receive the generated indoor sound, and output the received indoor sound from the speaker 16.

Generally, the vehicle control device 100 includes at least one processor 102 and at least one storage device 104. The processor 102 executes various processes. Examples of the processor 102 include CPU (Central Processing Unit), GPU (Graphics Processing Unit), ASIC (Application Specific Integrated Circuit), FPGA (Field-Programmable Gate Array), and the like. The storage device 104 stores various types of information. Examples of the storage device 104 include volatile memory, non-volatile memory, HDD (Hard Disk Drive), SSD (Solid State Drive), and the like.

### 2. Output Control of the Electric Motor

An electric motor used as a drive force source of a conventional battery electric vehicle differs greatly from an internal combustion engine which has been used as a drive force source of a conventional automotive vehicle. Due to differences in the torque-characteristics of the power system, conventional vehicles require transmissions, whereas battery electric vehicle generally do not include transmissions. Also, a typical battery electric vehicle does not include a manual transmission operated by drivers. Therefore, there is a great difference in driving sensation between the driving of MT engine vehicles and the driving of battery electric vehicle.

On the other hand, the electric motor can relatively easily control the torque by controlling the applied voltage and field. Therefore, in the electric motor, it is possible to obtain a desired torque characteristic within the operating range of the electric motor by performing appropriate control. Taking advantage of this feature, the torque of battery electric vehicle can be controlled to simulate torque properties specific to MT engine vehicles. It is also possible to provide battery electric vehicle with a pseudo-manual transmission so that drivers can obtain driving sensations such as MT engine vehicles. As a result, MT engine vehicles can be simulated in battery electric vehicle.

In an embodiment, the power of the electric motor 18 is controlled to simulate torque-characteristics specific to MT engine-vehicle. By controlling the power of the electric motor 18, the drivers of battery electric vehicle 10 can feel as if they are driving MT engine vehicles. The control mode of the electric motor 18 for simulating the torque-characteristics specific to MT engine-vehicle is hereinafter also referred to as “manual mode”. The control mode of the electric motor 18 for operating battery electric vehicle 10 as a common battery electric vehicle is hereinafter also referred to as “auto mode”.

### 3. Virtual Engine Sound Output Control

In the control system according to the embodiment, the output control of the electric motor is performed in combination with the output control of the virtual engine sound. FIG. 2 is a block diagram illustrating an example of a functional configuration of the vehicle control device 100 related to the output control of the virtual engine sound. The vehicle control device 100 includes an information acquiring unit 110, a vehicle sound source managing unit 120, an engine sound generating unit 130, and a sound output control unit 140 as functional blocks related to a virtual engine sound. These functional blocks are realized by, for example, cooperation of the processor 102 and the storage device 104.

The information acquiring unit 110 acquires information BEV related to battery electric vehicle 10. The information BEV includes information on the driving condition of battery electric vehicle 10 and information on the driving condition of battery electric vehicle 10. Further, the information BEV includes the present setting information of the driving mode of battery electric vehicle 10. The information BEV is typically detected by various sensors 12 and various switches 14. A part of the information regarding the driving environment of battery electric vehicle 10 may be acquired by combining the information detected by the various sensors 12 with the map data. The information detected by the various sensors 12 is, for example, position information of battery electric vehicle 10.

The informational BEV also includes a virtual engine rotational speed Ne. Here, it is assumed that battery electric vehicle 10 uses the virtual engine as a drive force source. The virtual engine rotational speed Ne is a rotational speed of the virtual engine when battery electric vehicle 10 is assumed to be driven by the virtual engine. For example, the information acquiring unit 110 may calculate the virtual engine rotational speed Ne so as to increase as the wheel speed increases. Also, battery electric vehicle 10 may be provided with a manual mode. In this case, the information acquiring unit 110 may calculate the virtual engine rotational speed Ne in the manual mode based on the wheel speed, the total reduction ratio, and the slip-rate of the virtual clutch.

The vehicle sound source managing unit 120 stores sound source data EVS of the engine vehicle used for generating the virtual engine sound. The vehicle sound source managing unit 120 is mainly implemented by the storage device 104. Typically, the sound source data EVS includes a plurality of types of sound source data. The plurality of types of sound source data include, for example, sound source data of sounds caused by engine combustion (for low rotational speed, medium rotational speed, and high rotational speed), and sound source data of sounds caused by operation of a drive system such as a gear (for low rotational speed, medium rotational speed, and high rotational speed). Further, the plurality of types of sound source data include, for example, sound source data of noise sound, sound source data of event sound (e.g., engine sound), and the like. Each sound source data is generated in advance through a simulation based on an engine model and a vehicle model of the engine vehicle, or the like. Each sound source data is flexibly adjustable. That is, at least one of the sound pressure and the frequency of the sound indicated by the sound source data can be flexibly adjusted.

The engine sound generating unit 130 (engine sound simulator) is a simulator that generates a virtual engine sound. The engine-sound generating unit 130 acquires at least a part of the information BEV from the information acquiring unit 110. In particular, the engine sound generating unit 130 acquires information on the virtual engine rotational speed Ne and the vehicle speed from the information acquiring unit 110. Further, the engine sound generating unit 130 reads the sound source data EVS of the engine vehicle from the vehicle sound source managing unit 120. Then, the engine sound generating unit 130 combines one or more sound source data included in the sound source data EVS of the engine vehicles. As a result, the engine sound generating unit 130 generates a virtual engine sound according to battery electric vehicle 10 operating conditions (virtual engine rotational speed Ne and vehicle speed). The engine sound data EGS is data indicating the generated virtual engine sound.

Note that the generation of the virtual engine sound is a well-known technique, and the generation method of the virtual engine sound applicable to the present disclosure is not particularly limited. For example, a virtual engine sound may be generated by a well-known engine sound simulator employed in a game or the like. A virtual engine rotational speed Ne-frequency map and a virtual engine torque-sound pressure map may be provided. A method of increasing or decreasing the frequency of the virtual engine sound in proportion to the virtual engine rotational speed Ne and increasing or decreasing the sound pressure of the virtual engine sound in proportion to the virtual engine torque may be used. The sound output control unit 140 receives the engine sound data EGS

generated by the engine sound generating unit 130. Then, the sound output control unit 140 outputs the engine sound data EGS to the speaker 16. At the time of outputting the engine sound data EGS, the sound output control unit 140 controls the sound pressure of the virtual engine sound by controlling the amplifier by the sound output control unit 140. In addition, the sound-output control unit 140 changes the frequency of the virtual engine sound by controlling FMC (frequency modulator).

The vehicle sound source managing unit 120 may store sound source data EVS (EVS1, . . . , EVSn) of a plurality of types of engine vehicles corresponding to each of a plurality of vehicle types (1, . . . , n). That is, the vehicle sound source managing unit 120 may store the sound source data EVS of the engine vehicle for each vehicle type. Here, the sound source data EVSk (1≤k≤n) is generated in advance based on the engine model or the vehicle model of the corresponding vehicle type. The driver may designate a desired vehicle type from among a plurality of vehicle types. In this case, the engine sound generating unit 130 acquires the sound source data EVSk corresponding to the vehicle type designated by the drivers. Then, the engine sound generating unit 130 generates a virtual engine sound using the acquired sound source data EVSk of the engine vehicles. This allows the driver to feel as if he or she is driving his or her favorite vehicle type.

### 4. Driving Mode Setting

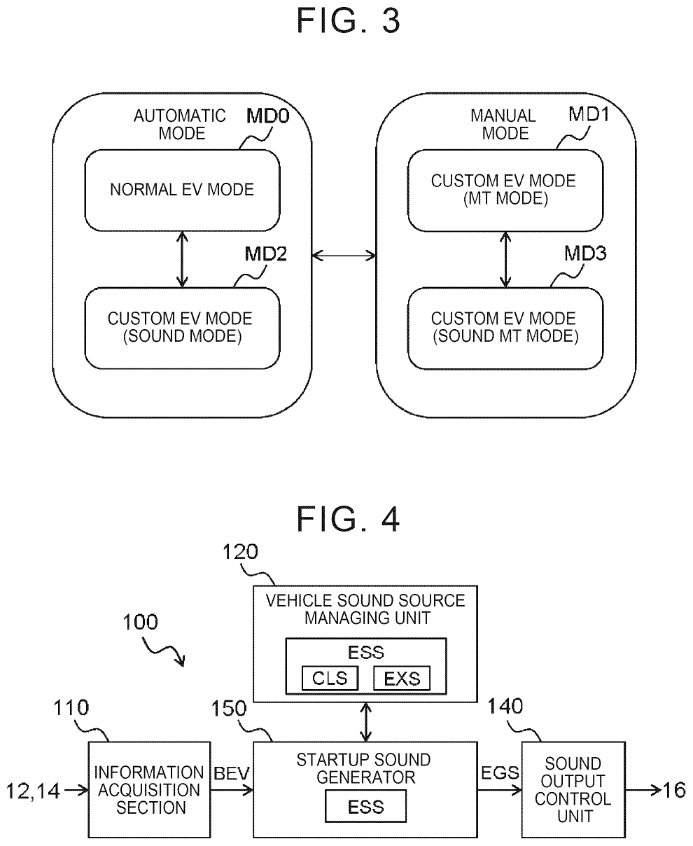

As described above, in the control system according to the embodiment, the output control of the electric motor is performed in combination with the output control of the virtual engine sound. Therefore, the automatic mode and the manual mode described in the description of the output control of the electric motor are subdivided in consideration of the execution of the output control of the virtual engine sound. FIG. 3 is a diagram illustrating a driving mode assumed in the embodiment. In the embodiment shown in FIG. 3, the auto mode has a normal EV mode MD0 and a custom EV mode MD2. The manual mode has a custom EV mode MD1 and a MD3.

The normal EV mode MD0 and the custom EV mode MDI are driving modes in which only the power control of the electric motor is performed. In the normal EV mode MD0, normal control for operating battery electric vehicle 10 as a common battery electric vehicle is performed. The normal EV mode MD0 is an exemplary “normal mode” of the present disclosure. In the custom EV mode MD1, control is performed to operate battery electric vehicle 10 to simulate the torque-characteristics of MT engine vehicles. The custom EV mode MD1 is also referred to as MT mode.

The custom EV mode MD2 and MD3 are driving modes in which the output-control of the virtual engine sound is performed. The power control of the electric motor is also performed in the custom EV modes MD2 and MD3. However, the power control of the electric motor in the custom EV mode MD2 is the same as that in the normal EV mode MD0. Also, the power control of the electric motor in the custom EV mode MD3 is the same as that in the custom EV mode MD1. The custom EV mode MD2 and MD3 are exemplary of the “sound mode” disclosed herein. The custom EV mode MD3 is also referred to as a sound MT mode.

The switching of the driving modes shown in FIG. 3 occurs between any two types of driving modes. The switching of the driving mode is performed on the basis of an intention indication of the switching by the driver. For example, the driver performs the intention indication by operating the mode changeover switch. In another example, the driver makes an indication of intention by a predetermined gesture. In this case, for example, the intention indication is confirmed by recognizing a predetermined gesture through analysis of the camera image. In yet another example, the driver makes an indication of intent by issuing a predetermined sound. In this case, for example, the intention indication is confirmed by recognizing the predetermined voice through analysis of the microphone voice.

### 5. Virtual Engine Startup Sound Output Control

The virtual engine sound includes a startup sound of the virtual engine. The startup sound of the virtual engine is a sound generated when the virtual engine is started, and includes a sound (cranking sound) generated by cranking of the virtual engine and a sound (explosion sound) generated after the first explosion of the virtual engine. FIG. 4 is a block diagram illustrating an example of a functional configuration of the vehicle control device 100 related to the output control of the startup sound of the virtual engine. The vehicle control device 100 includes a startup sound generating unit 150 in addition to the information acquiring unit 110, the vehicle sound source managing unit 120, and the sound output control unit 140 illustrated in FIG. 2 as functional blocks related to the startup sound of the virtual engine.

The startup sound generating unit 150 generates a startup sound of the virtual engine. The startup sound generating unit 150 acquires at least a part of the information BEV from the information acquiring unit 110. In particular, the startup sound generating unit 150 acquires, from the information acquiring unit 110, the startup operation signals from the various switches 14 (start switches) and the present setting information of the driving mode of battery electric vehicle 10. Further, the startup sound generating unit 150 reads the startup sound source data ESS (the cranking sound data CLS and the explosion sound data EXS) from the vehicle sound source managing unit 120. The startup sound source data ESS is data included in the sound source data EVS of the engine-vehicle described with reference to FIG. 2. Then, the startup sound generating unit 150 generates a startup sound of the virtual engine based on the startup sound source data ESS. The engine sound data EGS illustrated in FIG. 4 is data indicating the generated startup sound of the virtual engine.

In addition, the startup sound generating unit 150 outputs the engine sound data EGS to the sound output control unit 140. The output of the engine sound data EGS from the startup sound generating unit 150 to the sound output control unit 140 is continued until, for example, a driving operation signal from the various sensors 12 is input to the information acquiring unit 110. The various sensors 12 are sensors for detecting driving operations such as a shift position sensor and an accelerator position sensor, for example.

Here, in a general engine, if the operation time of the start switch is insufficient, the transition from cranking to the first explosion of the engine may fail. Therefore, the startup sound generating unit 150 generates the engine sound data EGS based on the magnitude relation between the input duration time (Input duration time) DT of the startup operation signal and the regulation time RT (Regulation time). The regulation time RT can be set in advance as a time enough to shift from cranking to the first explosion of the engine. The regulation time RT is, for example, about 1 to 3 seconds. When the startup sound source data ESS is stored for each vehicle type, the regulation time RT may be set for each vehicle type.

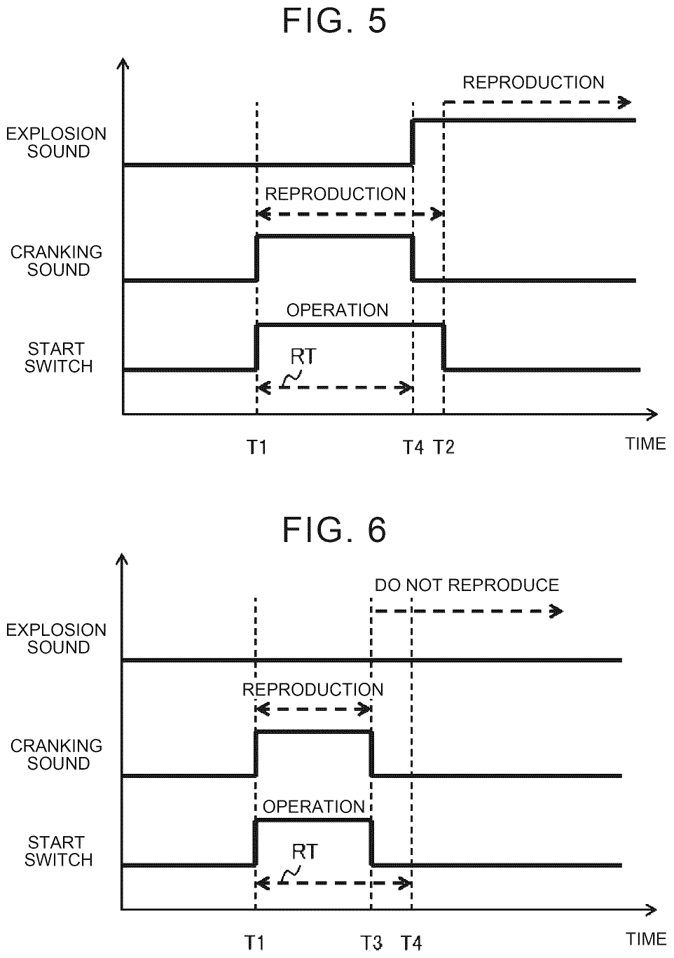

FIG. 5 and FIG. 6 are diagrams for explaining exemplary generation of the engine sound data EGS by the startup sound generating unit 150. In the embodiment shown in FIGS. 5 and 6, the start switch is pressed down at the time T1. In the embodiment illustrated in FIG. 5, the depression operation is continued until the time T2. On the other hand, in the embodiment illustrated in FIG. 6, the depression is continued until the time T3 (<time T2). Therefore, in the example shown in FIG. 5, the input duration time DT is longer, and in the example shown in FIG. 6, the input duration time DT is shorter than the regulation time RT.

In an embodiment, the input duration time DT may be longer than the regulation time RT (FIG. 5). In such cases, in order to generate a startup sound in which the transition from cranking to the first explosion of the engine has succeeded, the startup sound including the cranking sound is reproduced from the time T1 until the regulation time RT elapses, and the startup sound including the explosion sound is reproduced after the time T4 when the regulation time RT elapses. On the other hand, there is a case where the input duration time DT is shorter than the regulation time RT (FIG. 6). In such cases, in order to generate a startup sound in which the transition from cranking to the first explosion of the engine fails, the startup sound including the cranking sound is reproduced from the time T1 to the time T3, and the reproduction of the explosion sound is not switched to the reproduction of the explosion sound after the time T3. That is, the explosion sound is not reproduced. By changing the reproduction mode of the startup sound in this way, it is possible to improve the reproducibility of the startup sound of the engine vehicle.

The regulation time RT may be changed based on the accumulated total NS of the count of times that the switching from the reproduction of the cranking sound to the reproduction of the explosion sound is performed or the accumulated total NF of the count of times that the switching is not performed. For example, as the accumulated total NT increases, the regulation time RT may be shortened, and the regulation time RT may be changed so that the transition from cranking to the first explosion of the engine is likely to be successful. Further, as the accumulated total NT increases, the regulation time RT may be extended, and the regulation time RT may be changed so that the transition from cranking to the first explosion of the engine is difficult to succeed. Such changes can provide battery electric vehicle 10 drivers with an engine vehicle-specific experience that engine startup may fail.

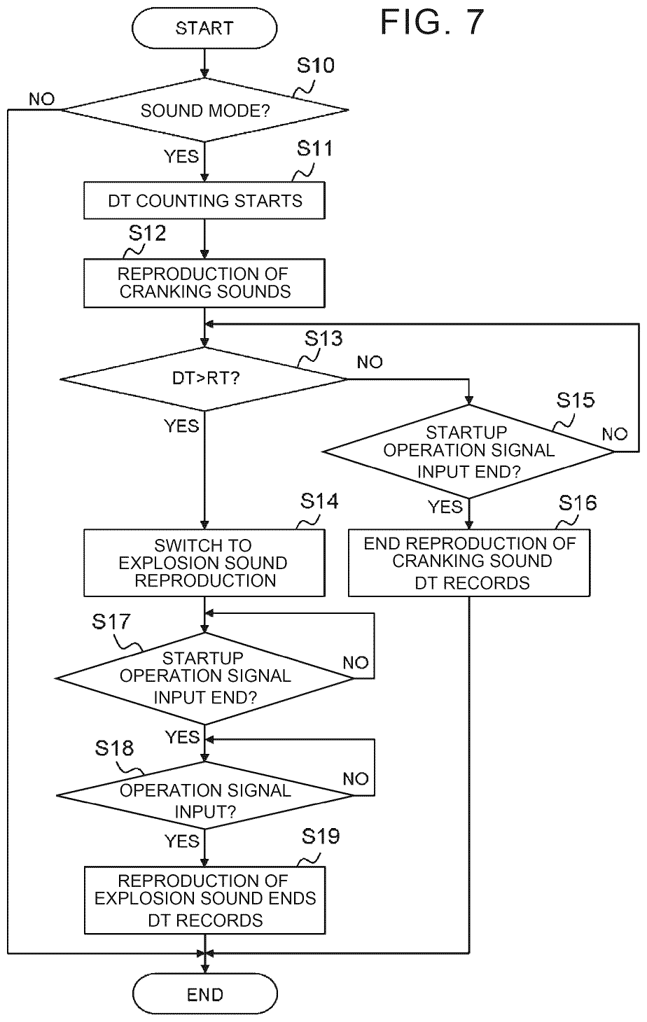

FIG. 7 is a flowchart illustrating a flow of a computer process (startup sound output processing) particularly related to the embodiment. The flowchart illustrated in FIG. 7 is executed by the processor 102 when, for example, a startup operation signal is input to the vehicle control device 100.

In the process illustrated in FIG. 7, first, it is determined whether or not the present driving mode of battery electric vehicle 10 corresponds to the sound mode (S10). In S10 process, first, the present driving mode is specified from the setting information of the driving mode included in the information BEV. Then, it is determined whether or not the specified driving mode corresponds to the custom EV mode MD2 or MD3 described with reference to FIG. 3. When S10 determination is negative, that is, when the specified driving mode corresponds to the normal EV mode MD0 or the custom EV mode MD1 described with reference to FIG. 3, the process exits the process routine.

If S10 determination is affirmative, counting of the input duration time DT is started (S11) and reproduction of the cranking sound is started (S12). In S11 process, the input duration time DT is counted, for example, as the elapsed time from the beginning point in time of the process routine. In S12 process, the cranking sound is reproduced based on the startup sound source data ESS (cranking sound data CLS). When the cranking sound data CLS is stored for each vehicle type, the cranking sound may be reproduced based on the selected vehicle type.

Following S12 process, it is determined whether the input duration time DT has exceeded a regulation time RT (S13). If S13 is positive, it is S14 to reproduction of the explosion sound. In S14 process, the explosion sound is reproduced based on the startup sound source data ESS (explosion sound data EXS). When the explosion sound data EXS is stored for each vehicle type, the cranking sound may be reproduced on the basis of the selected vehicle type.

If S13 determination is negative, it is determined whether or not input of the startup operation signal has ended (S15). The fact that the input of the startup operation signal is ended means that the press-down operation of the start switch is completed. Therefore, when S15 determination is affirmative, the reproduction of the cranking sound is ended (S16). In addition, the current input-duration time DT is recorded (S16). The recorded input-duration time DT is used, for example, to adjust the regulation time RT described above. If S15 determination is negative, the process returns to S13 process.

Subsequent to S14 process, it is determined whether or not input of the startup operation signal has been ended (S17). The content of S17 process is the same as that of S15 process. When S17 determination is affirmative, it is determined whether or not the driving operation signal is inputted to the vehicle control device 100 (S18). The fact that the driving operation signal has been inputted means that the driving operation of battery electric vehicle 10 has been performed. Therefore, if S18 determination is affirmative, the reproduction of the explosion sound is ended (S19). In addition, the current input-duration time DT is recorded (S19). The recorded input duration time DT is used, for example, to adjust the regulation time RT described above.

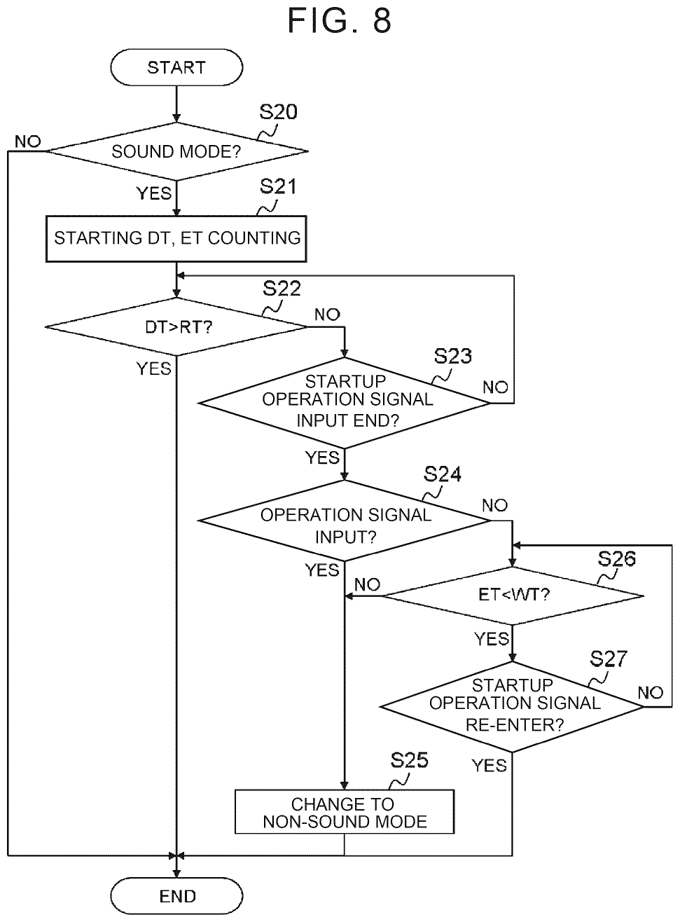

FIG. 8 is a flowchart illustrating a flow of computer processing (mode setting processing) related to the embodiment. The flowchart illustrated in FIG. 8 is executed by the processor 102 when, for example, a startup operation signal is input to the vehicle control device 100.

In the routine shown in FIG. 8, first, it is determined whether or not the present driving mode of battery electric vehicle 10 corresponds to the sound mode (S20). The content of S20 process is the same as that of S10 process of FIG. 7. If S20 determination is positive, then counting of the input duration time DT and the elapsed time (Elapsed Time) ET is started (S21). The input duration time DT is as described above. The elapsed time ET is calculated from the point in time of inputting the startup operation signal. The starting point in time of the elapsed time ET may be the same as that of the input duration time DT (i.e., at the beginning of the process).

Following S21 process, it is determined whether the input duration time DT has exceeded a regulation time RT (S22). The content of S22 process is the same as that of S13 process of FIG. 7. If the result of S22 is affirmative, the process exits. In this case, the driving mode is maintained in the sound mode.

If S22 determination is negative, it is determined whether or not input of the startup operation signal has been ended (S23). The content of S23 process is the same as that of S15 process of FIG. 7. If S23 determination is negative, the process returns to S22 process.

When S23 determination is affirmative, it is determined whether or not the driving operation signal is inputted to the vehicle control device 100 (S24). The content of S24 process is the same as that of S18 process of FIG. 7. If S24 determination is positive, the driving mode is changed to the non-sound mode (that is, the normal EV mode MD0 or the custom EV mode MD1 (S25).

If S24 determination is negative, it is determined whether the elapsed time ET is less than the waiting time (Waiting Time) WT (S26). When S26 determination is negative, that is, when the elapsed time ET is equal to or larger than the waiting time WT, S25 process is performed.

Even when the reproduction of the cranking sound is not switched to the reproduction of the explosion sound, battery electric vehicle 10 power supply is activated when the start switch is operated. Therefore, battery electric vehicle 10 can travel. On the other hand, a driver expecting to reproduce the output of the startup sound of the virtual engine is assumed to retry the operation of the start switch when only the cranking sound is reproduced and the explosion sound is not reproduced. In such a case, it is inconvenient for the driver to change to the non-sound mode.

Therefore, in the embodiment, when the elapsed time ET is less than the waiting time WT, S27 process is performed in order to wait for the re-input of the startup operation signal. In other words, if S26 determination is affirmative, it is determined in S27 process whether or not a startup operation signal has been inputted to the vehicle control device 100. If S27 determination is affirmative, the process exits. Accordingly, the driving mode is maintained in the sound mode, and the processing routine of FIG. 7 is started by the input of the startup operation signal.

What is claimed is:

1. A vehicle control system that generates, in a vehicle cabin of a real vehicle that includes an electric motor as a drive force source, a virtual engine sound generated in a virtual vehicle that includes a virtual engine as a drive force source, the vehicle control system comprising:
one or multiple storage devices that store startup sound source data of the virtual engine;
one or multiple processors that generate sound to be output from a speaker of the real vehicle; and
a startup input device of the real vehicle, wherein,
when a startup operation signal is input from the startup input device, the one or multiple processors perform startup sound output processing for outputting, to the speaker, startup sound of the virtual engine that is generated based on the startup sound source data,
the startup sound source data includes cranking sound data that is generated in conjunction with cranking of the virtual engine, and explosion sound data following a first explosion of the virtual engine, and
the startup sound output processing includes
counting input duration time of the startup operation signal, and
switching from reproduction of the startup sound based on the cranking sound data to reproduction of startup sound based on the explosion sound data when the input duration time exceeds a regulation time.

2. The vehicle control system according to claim 1, wherein the startup sound output processing includes ending reproduction of the startup sound based on the cranking sound data, and not performing switching from reproduction of the startup sound based on the cranking sound data to reproduction of the startup sound based on the explosion sound data, when input of the startup operation signal ends before the input duration time exceeds the regulation time.

3. The vehicle control system according to claim 1, wherein
the one or multiple processors further perform regulation time changing processing of changing the regulation time,
the regulation time changing processing includes
calculating at least one of an accumulated total count of times of performing switching from reproduction of the startup sound based on the cranking sound data to reproduction of the startup sound based on the explosion sound data in the startup sound output processing, and an accumulated total count of times of not performing the switching, and
shortening or extending the regulation time, based on at least one of the accumulated total count of times of performing the switching and the accumulated total count of times of not performing the switching, and
the regulation time is shortened as the accumulated total count of times of performing switching increases, and the regulation time is extended as the accumulated total count of times of not performing switching increases.

4. The vehicle control system according to claim 1, wherein
the one or multiple processors further perform mode setting processing of setting a driving mode of the real vehicle,
the driving mode including a normal mode in which generating of the virtual engine sound including the startup sound of the virtual engine is not performed, and a sound mode in which the generating of the virtual engine sound is performed,
the mode setting processing includes switching from the sound mode to the normal mode in accordance with to the input duration time, when the startup operation signal is input from the startup input device in a state in which the driving mode is set to the sound mode, and
when the input of the startup operation signal ends before the input duration time exceeds the regulation time, and elapsed time from a point in time of input of the startup operation signal is no shorter than a waiting time that is longer than the regulation time, the sound mode is switched to the normal mode.

5. A vehicle control method for generating, in a vehicle cabin of a real vehicle that includes an electric motor as a drive force source, a virtual engine sound generated in a virtual vehicle that includes a virtual engine as a drive force source, the vehicle control method comprising:
performing startup sound output processing by one or multiple processors that generate sound to be output from a speaker of the real vehicle, for outputting, from the speaker of the real vehicle, startup sound of the virtual engine that is generated based on startup sound source data of the virtual engine stored in one or multiple storage devices, when a startup operation signal is input from a startup input device of the real vehicle, wherein
the startup sound source data includes cranking sound data that is generated in conjunction with cranking of the virtual engine, and explosion sound data following a first explosion of the virtual engine, and
the startup sound output processing includes
counting input duration time of the startup operation signal, and
switching from reproduction of the startup sound based on the cranking sound data to reproduction of startup sound based on the explosion sound data when the input duration time exceeds a regulation time.
